(19) United States
(12) Patent Application Publication
(10) Pub. No.: US 2006/0145032 A1
(43) Pub. Date: Jul. 6, 2006

(54) LEAD HOLDING APPARATUS FOR A DISPLAY DEVICE

(76) Inventors: Kuan-Hong Hsieh, Shenzhen (CN); Te-Hsu Wang, Shenzhen (CN); Chih-Jen Sun, Shenzhen (CN); Fu-Min Wang, Shenzhen (CN)

Correspondence Address: NORTH AMERICA INTELLECTUAL PROPERTY CORPORATION, P.O. BOX 506, MERRIFIELD, VA, 22116, US

(21) Appl. No.: 11/163,424

(22) Filed: Oct. 18, 2005

(30) Foreign Application Priority Data
Dec. 30, 2004 (CN) 200420103607.4

(51) Int. Cl. F16L 3/08

(52) U.S. Cl. 248/65

(57) ABSTRACT

A lead holding apparatus is provided. The lead holding apparatus includes two brackets. The brackets form a receiving space so that leads can be received and held therein. Further, an opening is defined between top portions of the brackets. Opposing sides of the top portions of the brackets at the opening are smooth wavelike curves. An oblique maximum uniform width between the sides is slightly greater than a diameter of a lead, so that the lead can be passed through the opening and received into the receiving space conveniently. A non-oblique minimum uniform width between the sides is slightly less than the diameter of the lead, so that the lead can be held in the receiving space without escaping out through the opening.

### FIELD OF THE INVENTION

The present invention relates to a lead holding apparatus, and particularly to a lead holding apparatus used in a display device.

### DESCRIPTION OF RELATED ART

In general, electronic devices such as computers are connected to one or more associated external devices such as monitors and keyboards through various lead connections. For example, a personal computer is connected to an external power supply through a power lead in order to obtain primary power, and is connected to an audio amplifier in order to provide good acoustics. Typically, a plurality of leads are connected between the electronic device and the external devices. If the leads are arranged in a disorderly or unsystematic way, it is difficult to deal with and maintain them. It is preferable that the leads are trimmed and arranged in order, thereby conveniently distinguishing one lead from another. Commonly, lead ties are used to bind the leads together and keep the leads arranged in an orderly manner. However, when the leads are enclosed by lead ties, it can be difficult to distinguish the leads and readily see the connection relationships between the various devices. Maintenance workers may have to remove the lead ties so as to distinguish among the leads. Further, after finishing maintenance, the workers have to use new lead ties to bind the leads again. These requirements are not only time-consuming, but also waste materials.

Therefore, what is needed is a lead holding apparatus which easily and conveniently holds leads therein.

### SUMMARY OF INVENTION

A lead holding apparatus is provided herein. The lead holding apparatus includes two brackets. The brackets form a receiving space so that leads can be received and held therein. Further, an opening is defined between top portions of the brackets. Opposing sides of the top portions of the brackets at the opening are smooth wavelike curves. An oblique maximum uniform width between the sides is slightly greater than a diameter of a lead, so that the lead can be passed through the opening and received into the receiving space conveniently. A non-oblique minimum uniform width between the sides is slightly less than the diameter of the lead, so that the lead can be held in the receiving space without escaping out through the opening.

Further features and advantages will be provided or will become apparent in the course of the following detailed description.

### BRIEF DESCRIPTION OF DRAWINGS

FIG. 1 is a schematic, isometric view of a lead holding apparatus attached on a chassis of a display device, in accordance with a preferred embodiment of the present invention;

FIG. 2 is a top plan view of part of FIG. 1, but viewed from another aspect, and showing an opening structure of the lead holding apparatus; and

FIG. 3 is similar to FIG. 1, but showing three leads held in the lead holding apparatus.

### DETAILED DESCRIPTION

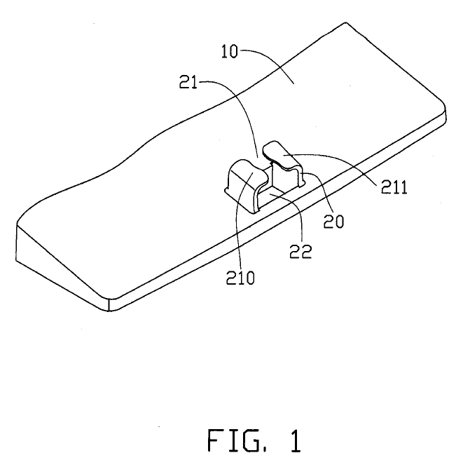

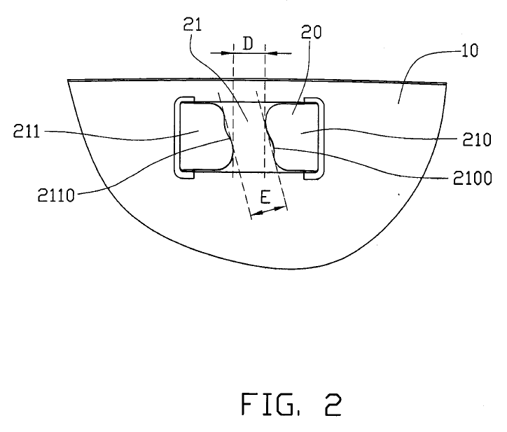

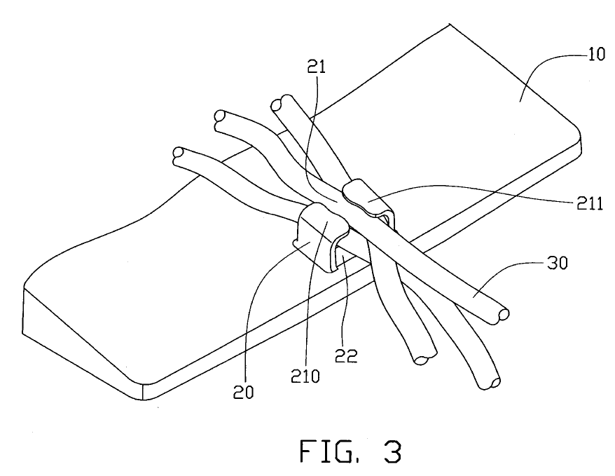

Referring to FIGS. 1 and 2, a lead holding apparatus used in a display device in accordance with a preferred embodiment of the present invention is shown. In a typical application of the preferred embodiment, the lead holding apparatus 20 is mounted on a chassis 10 of the display device. The lead holding apparatus 20 includes two generally L-shaped brackets 210, 211. The brackets 210, 211 are oriented generally symmetrically opposite each other, thereby forming a receiving space 22 therebetween. Leads such as leads can be received and held in the receiving space 22. Further, top portions of the brackets 210, 211 maintain a distance therebetween, thereby forming an opening 21. Two opposing sides 2100, 2110 of the top portions of the brackets 210, 211 respectively define smooth wavelike curves. An oblique maximum uniform width E between the sides 2100, 2110 is slightly greater than a diameter of a lead 30 (see FIG. 3), so that the lead 30 can be received into the receiving space 22 of the lead holding apparatus 20 conveniently. Additionally, a minimum non-oblique width D between the sides 2100, 2110 is slightly less than the diameter of the lead 30 so that the lead 30 can be non-obliquely held in the receiving space 22 of the lead holding apparatus 20 without escaping out through the opening 21. Further, the lead holding apparatus 20 can be of an elastic material such as plastic, and thus can be elastically deformed if necessary. For example, in the case of a lead having a diameter slightly greater than the oblique maximum uniform width E, either or both of the brackets 210, 211 can be elastically deformed, so that the opening 21 is enlarged. The lead can then be readily received in the receiving space 22, whereupon the brackets 210, 211 rebound and retain the lead in the receiving space 22.

FIG. 3 shows the lead holding apparatus 20 holding three leads 30. In use of the lead holding apparatus 20, each lead 30 can be aligned according to the oblique maximum uniform width E, and then can be easily passed through the opening 21 and received into the receiving space 22. After all the leads 30 are thus received, they can be arranged parallel to each other in an alignment according to the minimum non-oblique width D. Thereby, the leads 30 cannot escape out through the opening 21. If the lead holding apparatus 20 is made of an elastic material, the opening 21 can be elastically enlarged for the case when the diameter of any of the leads 30 is slightly greater than the oblique maximum uniform width E. Further, either or both of the opening 21 and the receiving space 22 can sized and configured according to the diameter or diameters of the leads 30 and the quantity of the leads 30 needing to be held in the receiving space 22. That is, the opening 21 and the receiving space 22 are not limited to the present embodiments described and illustrated.

Moreover, it is to be understood that the invention may be embodied in other forms without departing from the spirit thereof. Thus, the present examples and embodiments are to be considered in all respects as illustrative and not restrictive, and the invention is not to be limited to the details given herein.

What is claimed is:

1. A lead holding apparatus for use in a display device, the lead holding apparatus comprising:
two spaced-apart brackets for cooperatively defining a receiving space therebetween, for one or more leads to be held therein, top portions of the brackets being adapted for maintaining a distance therebetween thereby defining an opening;
wherein two opposing sides of the brackets at the opening define smooth curves, an oblique maximum uniform width between the sides is slightly greater than a diameter or diameters of the leads, and a minimum non-oblique uniform width between the sides is slightly less than the diameter or diameters of the leads.

2. The lead holding apparatus of claim 1, wherein the lead holding apparatus is adapted to be mounted on a chassis of the display device.

3. The lead holding apparatus of claim 1, wherein the lead holding apparatus is made of elastic material.

4. The lead holding apparatus of claim 1, wherein the receiving space and the opening are determined by the lead's diameter and quantity.
